(19) United States
(12) Patent Application Publication
(10) Pub. No.: US 2006/0146155 A1
(43) Pub. Date: Jul. 6, 2006

(54) Area image sensor

(75) Inventor: Makoto Shimizu, Kyoto (JP)

Correspondence Address: HAMRE, SCHUMANN, MUELLER & LARSON, P.C., P.O. BOX 2902-0902, MINNEAPOLIS, MN, 55402, US

(73) Assignee: Rohm Co., Ltd., Kyoto-shi, Kyoto (JP)

(21) Appl. No.: 10/530,949

(22) PCT Filed: Oct. 10, 2003
(86) PCT No.: PCT/JP03/13096

§ 371 Date: Apr. 8, 2005

(30) Foreign Application Priority Data
Oct. 11, 2002 (JP) 2002-298667
Nov. 5, 2002 (JP) 2002-321014

(51) Int. Cl. H04N 5/335

(52) U.S. Cl. 348/308

(57) ABSTRACT

An area image sensor (1) includes a plurality of image pick-up elements (10, 20) arranged in a matrix including a plurality of element rows and a plurality of element columns. A plurality of signal lines (L11-L14) are allocated to a respective one of the element columns. Each of the signal lines includes an output terminal to which an A/D converter (30) is connected. Each of the image pick-up elements belonging to the one element column is connected to only one of the signal lines, and each of the signal lines is connected to at least one of the image pick-up elements belonging to the one element column.

### BACKGROUND OF THE INVENTION

1. Field of the Invention

The present invention relates to a CMOS area image sensor (two-dimensional image sensor) for incorporated into a digital camera, for example.

2. Description of the Related Arts

A prior art CMOS area image sensor is disclosed in JP-A 2001-36816, for example. As shown in FIG. 1 of the gazette, the prior art area image sensor includes a plurality of image pick-up elements arranged in a matrix. (Each of the image pick-up elements comprises a photodiode and a switching transistor.) A vertical line of image pick-up elements is called a “column”, whereas a horizontal line of image pick-up elements is called a “row”. A single signal line is provided in parallel with each column of the image pick-up elements, whereas a single address line is provided in parallel with each row of the image pick-up elements. To each signal line are connected image pick-up elements of the relevant column (more precisely, output terminals of the switching transistors). To each address line are connected image pick-up elements of the relevant row (more precisely, gates of the switching transistors). An A/D converter is connected to the output terminal of each signal line, and a shift register is connected to the output terminal of each A/D converter.

In the above-described area image sensor, address lines are successively selected one by one. Signal voltages are outputted from the image pick-up elements of the row corresponding to the selected address line to the A/D converters. The A/D converters compare the inputted signal voltages with reference voltage and output digital image signals to the shift register. The shift register outputs the digital image signals in synchronization with shift pulses. (The outputted data is called “image data”.)

The image data for one frame is obtained when scanning of all the address lines is completed and respective digital image signals corresponding to the image pick-up elements are outputted from the shift register. Therefore, when the frame rate is F_{R} (fps: frame/second) and the total number of the address lines is N_{A}, the A/D converter need to convert an analog signal voltage to a digital image signal within about 1/(F_{R}×N_{A}) second (cycle time).

Generally, a shorter cycle time causes poorer operation of the of the A/D converter. As noted above, the cycle time of the prior art sensor is 1/(F_{R}×N_{A}). Therefore, when the frame rate F_{R} is increased (with the N_{A} kept constant), there is a possibility that the A/D converter does not work properly.

### DISCLOSURE OF THE INVENTION

An object of the present invention, which is conceived under the circumstances described above, is to provide an area image sensor which is capable of increasing the frame rate without hindering the stable operation of the A/D converter.

According to a first aspect of the present invention, there is provided an area image sensor comprising a plurality of image pick-up elements arranged in a matrix including a plurality of element rows and a plurality of element columns, a plurality of signal lines allocated to a respective one of the element columns, and a plurality of A/D converters connected to the signal lines, respectively. The image pick-up elements belonging to the one the element column is connected to only one of the signal lines, and each of the signal lines is connected to at least one of the image pick-up elements belonging to the one element column.

Preferably, each of the image pick-up elements comprises a photoelectric conversion element, and a switching element connected to the photoelectric conversion element.

Preferably, two adjacent image pick-up elements belonging to the one element column are connected to different ones of the signal lines.

Preferably, the image sensor of the present invention further comprises a plurality of address lines and an address line selection circuit connected to the address lines. Each of the address lines is connected to the image pick-up elements of a respective one of the element rows, and the address line selection circuit selects plural ones of the address lines simultaneously.

Preferably, the image sensor of the present invention further comprises a shift register connected to the A/D converters.

According to a second aspect of the present invention, there is provided an area image sensor including a plurality of image pick-up elements arranged in a plurality of columns and a plurality of rows. The area image sensor comprises a plurality of signal lines allocated to a respective one or two of the columns of the image pick-up elements, and A/D converters connected to the signal lines, respectively. Small groups each consisting of successive image pick-up elements are defined in each of the columns of the image pick-up elements, and the number of the image pick-up elements included in each of the small groups corresponds to the number of the signal lines allocated to the column. The image pick-up elements included in each of the small groups are connected to different signal lines from each other. Further, large groups each consisting of at least two successive small groups are defined in each of the columns of the image pick-up elements, and in each of the large groups, there are at least two connection patterns of the image pick-up elements to the signal lines on a small group basis.

Preferably, in each of the columns of the image pick-up elements, the number of the small groups included in each of the large groups is powers of 2.

Preferably, two or more kinds of large groups differing from each other in number of the small groups included therein are defined in each of the columns of the image pick-up elements.

Preferably, the image sensor of the present invention further comprises address lines each of which is allocated to a respective one of the rows of the image pick-up elements and connected to all the image pick-up elements of the row, an address line selection circuit for selecting plural ones of the address lines simultaneously, a shift register for taking in digital signals outputted from each of the A/D converters and outputting the digital signals through a plurality of transfer lines, and a duplexer circuit or a multiplexer circuit for switching the transfer lines for outputting the digital signals.

Preferably, the A/D converter compares an inputted signal voltage with a predetermined reference voltage and outputs, to the shift register, a count value when the both voltages correspond to each other as a digital signal.

### BRIEF DESCRIPTION OF THE DRAWINGS

FIG. 1 is a circuit diagram showing a principal portion of an area image sensor according to a first embodiment of the present invention.

FIG. 2 is a circuit diagram of an image pick-up element of the image sensor.

FIG. 3 is a block diagram of an A/D converter of the image sensor.

FIG. 4A is a time chart showing the operation timing of the A/D converter.

FIG. 4B is a time chart showing a comparative example relative to the present invention.

FIG. 5 is a time chart showing another operation timing of the A/D converter.

FIG. 6 is a circuit diagram showing a principal portion of an area image sensor according to a second embodiment of the present invention.

FIG. 7 is a circuit diagram of an image pick-up element of the image sensor shown in FIG. 6.

FIG. 8 shows a connection pattern of the image pick-up elements.

FIG. 9 is a block diagram of an A/D converter used for the area image sensor of the second embodiment.

FIG. 10 shows the operation of the A/D converter.

FIG. 11 shows signal processing.

FIG. 12 shows another signal processing.

FIG. 13 shows still another signal processing.

FIG. 14 is a circuit diagram showing a principal portion of an area image sensor according to a third embodiment of the present invention.

FIG. 15 shows a connection pattern of the image pick-up elements of the area image sensor of the third embodiment.

FIG. 16A shows signal processing of a comparative example.

FIG. 16B shows signal processing in the area image sensor of the third embodiment.

FIG. 17 shows another signal processing in the area image sensor of the third embodiment.

FIG. 18 is a circuit diagram showing a principal portion of an area image sensor according to a fourth embodiment of the present invention.

FIG. 19 shows a connection pattern of the image pick-up elements of the area image sensor of the fourth embodiment.

FIG. 20 is a circuit diagram showing a principal portion of an area image sensor according to a fifth embodiment of the present invention.

FIG. 21 shows a connection pattern of the image pick-up elements of the area image sensor of the fifth embodiment.

FIG. 22 shows a variation of the fifth embodiment.

FIG. 23 shows a connection pattern of image pick-up elements of the variation.

### DETAILED DESCRIPTION OF THE PREFERRED EMBODIMENTS

Preferred embodiments of the present invention will be described below with reference to the accompanying drawings.

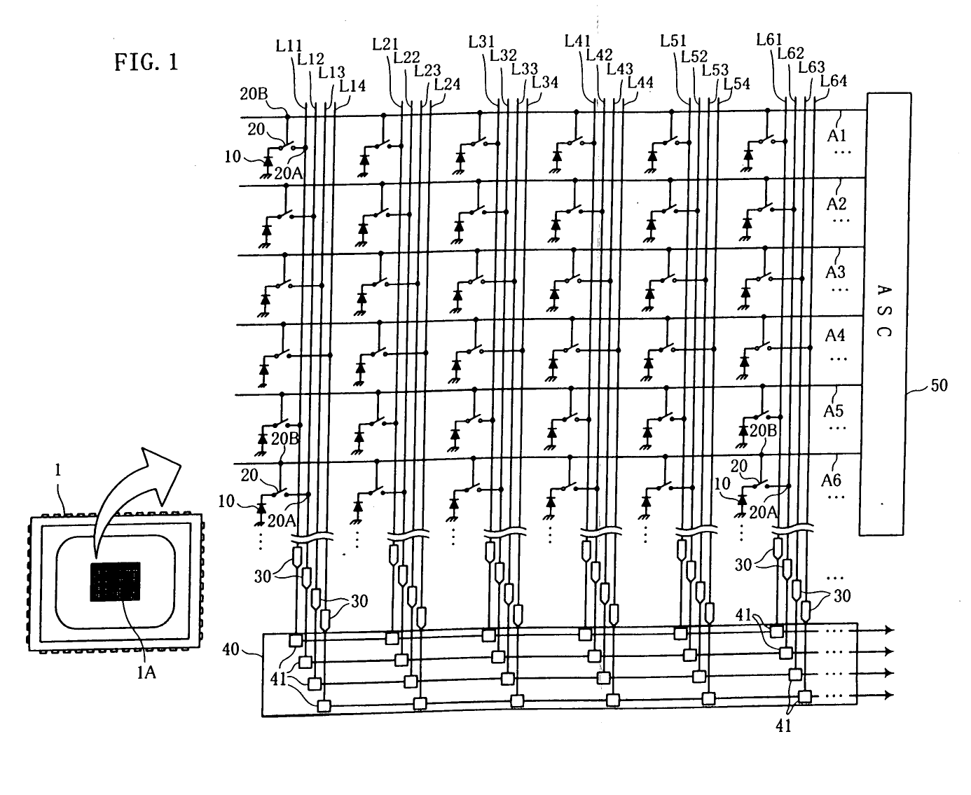

FIG. 1 is a block diagram of a CMOS area image sensor according to a first embodiment of the present invention. The area image sensor 1 may be used as a component of a digital camera, for example, but the present invention is not limited thereto.

The image sensor 1 includes a rectangular light receiving portion 1A, and the light receiving portion includes a plurality of photodiodes 10 and a plurality of switching elements 20. Each of the photodiodes 10 is paired with a respective one of the switching elements 20 to constitute a single image pick-up element. A unit area including such an image pick-up element corresponds to one pixel. The plurality of image pick-up elements are arranged in a matrix. Each vertical line of the image pick-up elements is called a “column”, whereas each horizontal line of the image pick-up elements is called a “row”.

Four signal lines Lij (i, j=1, 2, 3, . . . ) are provided correspondingly to each column of the image pick-up elements. For example, signal lines L11, L12, L13 and L14 are provided with respect to the first column of the image pick-up elements. Each of the signal lines is connected to output terminals 20A of corresponding plural switching elements. Similarly, signal lines L21, L22, L23 and L24 are provided with respect to the second column of the image pick-up elements. The output terminal of each signal line is connected to an analog-digital converter (A/D converter) 30, and the output terminal of each converter 30 is connected to a shift register 40.

A single address line Ak (k=1, 2, 3, . . . ) is provided with respect to each row of the image pick-up elements. For example, an address line A1 is provided with respect to the first row of the image pick-up elements, and the address line is connected to gates 20B of corresponding plural switching elements. Similarly, an address line A2 is provided with respect to the second row of the image pick-up elements. Each of the address lines is connected to an address line selection circuit (ASC) 50.

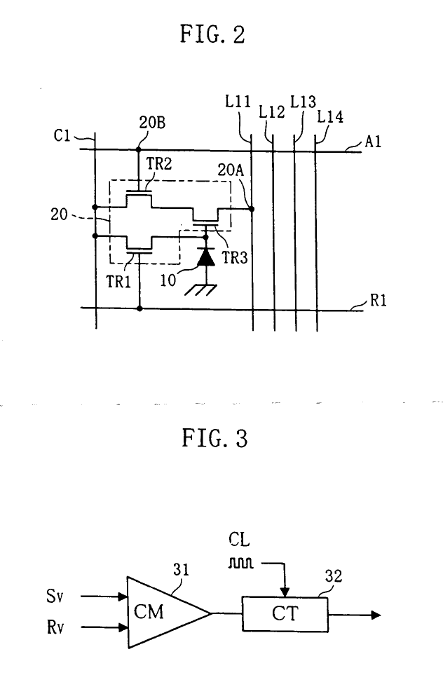

FIG. 2 is a circuit diagram of an image pick-up element. The switching element 20 comprises three transistors, i.e., a reset transistor TR1, a switching transistor TR2 and a source follower amplifier transistor TR3. The reset transistor TR1 and the switching transistor TR2 comprise CMOS devices. A reset line is provided with respect to each row (the reset line for the first row is indicated by reference sign R1), and a common line is provided with respect to each column (the common line for the first column is indicated by reference sign C1). (These lines are omitted in FIG. 1.) The reset transistor TR1 has a source, a gate and a drain which are connected to the output terminal of the photodiode 10, the reset line R1 and the common line C1, respectively. The switching transistor TR2 has a source, gate and a drain which are connected to the common line C1, the address line A1 and the source of the source follower amplifier transistor TR3, respectively. The source follower amplifier transistor TR3 has a gate connected to the output terminal of the photodiode 10, and a drain connected to the signal line L11. The contact point between the drain of the source follower amplifier transistor TR3 and the signal line L11 corresponds to the output terminal 20A of the switching element 20, whereas the contact point between the gate of the switching transistor TR2 and the address line A1 corresponds to the input/output gate 20B of the switching element 20. When the switching element 20 is turned on with the gate 20B in conduction, signal charge corresponding to the received amount of light flows from the photodiode 10 to the signal line L11, whereby signal voltage is inputted into the A/D converter 30 through the signal line.

Now, attention is focused on the connection of the switching elements 20 of the first column and the signal lines L11-L14. Every fourth switching element 20 of the first column is connected to a common signal line. Specifically, the output terminals 20A of the (1+4n)th switching elements 20 (n=0, 1, 2, . . . ) are connected to the signal line L11, whereas the (2+4n) th switching elements 20 are connected to the signal line L12. The output terminals of the (3+4n)th switching elements 20 are connected to the signal line L13, whereas the (4+4n) th switching elements 20 are connected to the signal line L14. (Other switching elements are connected likewise.) Technical advantages of such an arrangement will be described later.

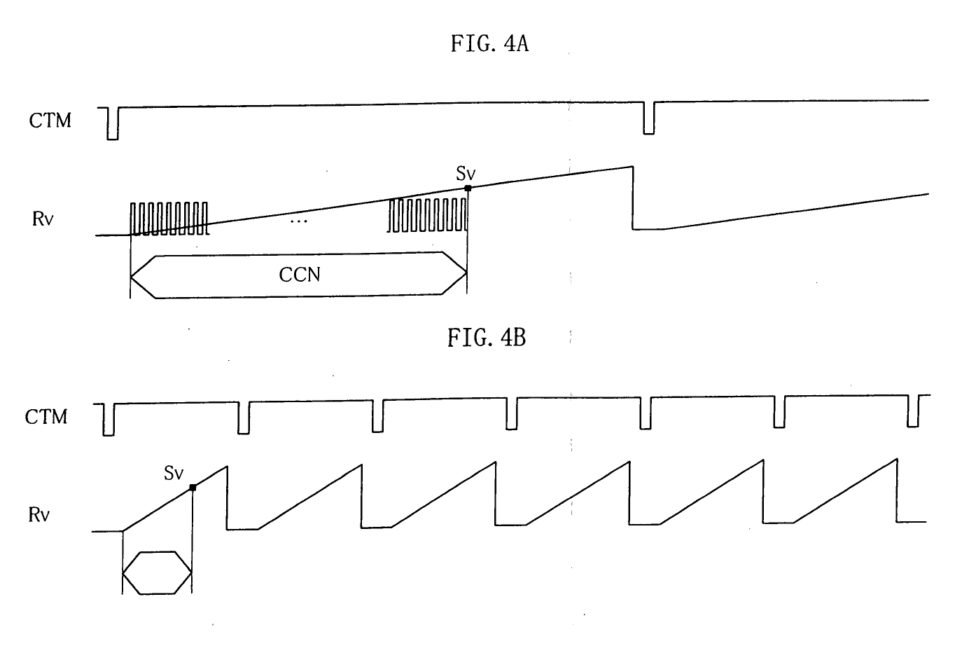

FIG. 3 is a block diagram showing the main structure of an A/D converter 30. The A/D converter 30 includes a comparator (CM) 31 and a counter (CT) 32. Signal voltage (Sv) as an analog signal is inputted into the comparator 31 through the signal line L, while reference voltage (Rv) which increases in proportion to an operation clock (See FIG. 4A) is also inputted into the comparator. The reference voltage is inputted at each selection cycle (cycle time (CTM)) of the address line selection circuit 50. The comparator 31 compares the signal voltage Sv inputted within the cycle time with the reference voltage Rv and outputs a latch signal to the counter 32 when the both voltages correspond to each other. The counter 32 counts the clock number. Upon receiving the latch signal from the comparator 31, the counter 32 outputs the clock count number (CCN) at that time point to the shift register 40 (FIG. 1) as a digital image signal.

The shift register 40 includes a plurality of registers 41 comprising flip-flop circuits, for example. Each of the registers 41 is connected to the output terminal of a corresponding A/D converter 30. As will be understood from FIG. 1, four converters 30 and four registers 41 are provided with respect to each column of the image pick-up elements. The registers 41 of the shift register 40 can be divided into four groups, and the registers 41 in the same group are connected to each other. Specifically, the registers 41 corresponding to the signal lines Li1 (i=1, 2, 3, . . . ) are connected to each other. The registers 41 corresponding to the signal line Li2 (i=1, 2, 3, . . . ) are connected to each other. (Other registers are connected likewise.) After the digital image signals are inputted from the A/D converters 30 into the registers 41, the shift register 40 outputs the digital image signals while successively transferring the signals from left to right between the registers 41 in synchronization with clocks, for example.

The address line selection circuit 50 selects four address lines at a time and turns on the image pick-up elements corresponding to the selected address lines. Specifically, the circuit 50 first selects the address lines A1-A4 and turns on the image pick-up elements corresponding to these address lines. (As a result, signal voltage is outputted from the image pick-up elements to the converters 30.) Then, after the cycle time CTM noted above has elapsed, the circuit selects the address lines A5-A8 and turns on the image pick-up elements corresponding to these address lines. Thereafter, the selection operation is repeated.

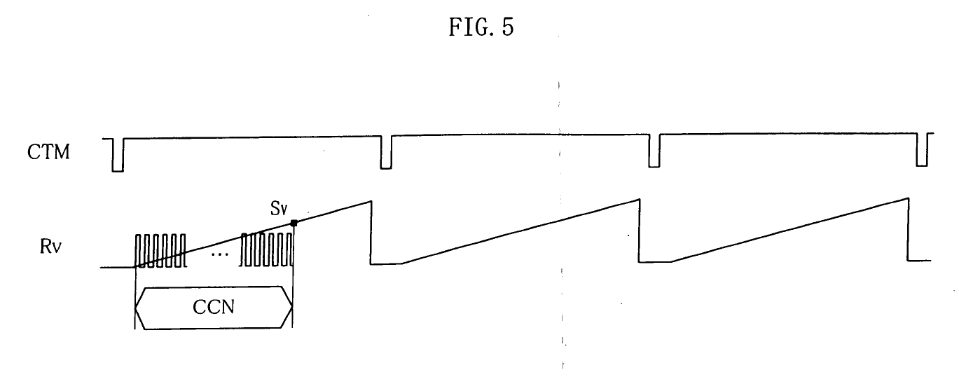

Now, the entire operation of the area image sensor 1 will be described with reference to FIGS. 4A, 4B and 5. FIGS. 4A and 5 are time charts showing the operation timing of the A/D converter 30, whereas FIG. 4B is a time chart of a prior art image sensor for comparison.

First, the address line selection circuit 50 selects the first to the fourth address lines A1-A4, collectively. As a result, the switching elements 20 of the first to the fourth rows connected to the address lines A1-A4 are turned on. At the same time, from each of the photodiodes 10 paired with the turned-on switching elements 20, signal voltage produced by photoelectric conversion is supplied to the A/D converter 30 through the relevant one signal line (See FIG. 1).

As shown in FIG. 4A, within the cycle time CTM, each A/D converter 30 compares the increasing reference voltage Rv with the signal voltage Sv. Then, the A/D converter 30 outputs, to the shift register 40, the clock count number CCN at the time point when the both voltages correspond to each other as a digital image signal. (This image signal is outputted from the shift register 40 during when the fifth to the eighth address lines are subsequently selected.)

After the selection of the address lines A1-A4 is finished, the first through the fourth reset lines (only the reset line Rl is shown in FIG. 2) are selected to reset the photodiodes 10 of the first through the fourth rows, while, on the other hand, the fifth through the eighth address lines are selected to perform the operation similar to the above. By repeating such series of operation, image data for one frame corresponding to the entire light receiving portion 1A is obtained.

Now, the instance in which the frame rate is 60 fps and the total number of address lines is N is considered. In this instance, the processing time of each A/D converter 30 for one frame is 1/60 second. (In practice, a slight error is produced). Within this processing time, the A/D converter 30 performs A/D conversion N/4 times. Therefore, the time required for one A/D conversion (cycle time) is 1/(15×N) second. On the other hand, in the prior art method (in which a single signal line is provided with respect to each column, and address lines are selected one by one), A/D conversion is performed totally N times within the processing time for one frame ( 1/60 second). Therefore, the cycle time is 1/(60×N) second.

In this way, according to the present invention (FIG. 4A), the cycle time is four times longer than that of the prior art method (FIG. 4B), so that the rate of change of the reference voltage within one cycle time can be reduced. As a result, provided that the operation clock of the A/D converter is the same, the number of bits of digital image signal for one pixel can be increased (i.e., the gray scale level can be increased.) According to the present invention, the cycle time can be made one half of that shown in FIG. 4A (See FIG. 5). By shortening the cycle time CTM, the frame rate can be increased. In this case again, the cycle time according to the present invention is longer than that of the prior art method (FIG. 4B), and the gray scale level for one pixel can be made higher than that of the prior art method.

Further, according to the present invention, even when the operation clock of the A/D converter is set lower than that of the prior art method, it is possible to realize the gray scale level which is generally equal to or higher than that of the prior art method. Therefore, by lowering the operation clock, the power consumption by the A/D converter can be advantageously reduced.

Although a plurality of image pick-up elements are arranged in a matrix in the foregoing embodiment, the present invention is not limited thereto. For example, the image pick-up elements may be arranged in a honeycomb pattern. Further, five or more signal lines may be provided with respect to each column of the image pick-up elements.

In the foregoing embodiment, the switching elements 20 connected to a common signal line (e.g., the signal line L11) are not arranged adjacent to each other. However, the switching elements connected to a common signal line may be arranged adjacent to each other. Specifically, in the example shown in FIG. 1, the switching elements 20 belonging to the first column (the leftmost column) may be divided into four groups (first through fourth groups) each including switching elements arranged adjacent to each other. The switching elements 20 of the first group may be connected to the signal line L11, the switching elements 20 of the second group to the signal line L12, the switching elements 20 of the third group to the signal line L13 and the switching elements 20 of the fourth group to the signal line L14, for example. The number of groups into which the switching elements of each column are to be divided depends on the number of signal lines used for the column. For example, when five signal lines are used for one column, the switching elements 20 of that column are divided into five groups. In such a case, the sensor need be so designed that two or more switching elements 20 belonging to the same group (connected to a common signal line) do not turn on simultaneously.

The A/D converter 30 is not limited to one which utilizes a sloping reference voltage. For example, a successive approximation converter may be used. In this case, inputted signal voltage is successively compared with reference voltage produced digitally within the converter.

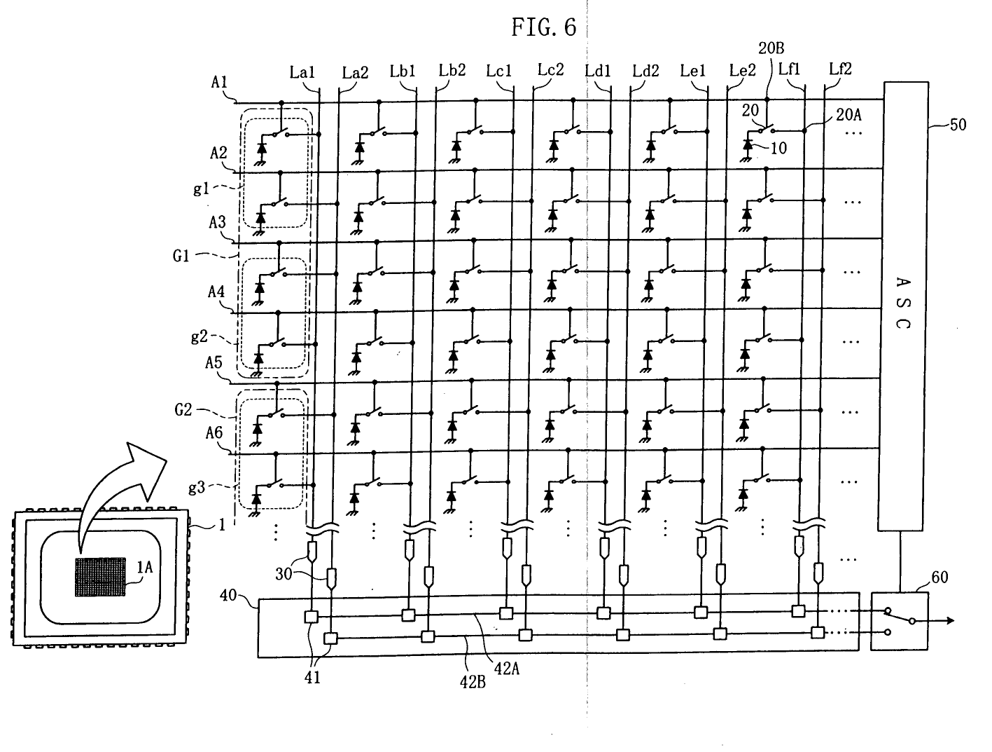

FIG. 6 is a block diagram of an area image sensor according to a second embodiment of the present invention. Among the structural elements of the image sensor of the second embodiment, those which are identical or similar to the structural elements of the first embodiment are indicated by the same reference signs as those used in the first embodiment. This holds true for the third through the fifth embodiments, which will be described later.

As shown in FIG. 6, the area image sensor 1 including an image pick-up portion 1A includes a plurality of photodiodes 10, a plurality of switching elements 20, a plurality of analog/digital converters (A/D converter) 30, a shift register 40, an address line selection circuit 50, a duplexer circuit 60, signal lines L extending vertically, and address lines A extending horizontally.

Each of the photodiodes 10 is connected to a respective one of the switching elements 20 to serve as an image pick-up element. The plurality of image pick-up elements are arranged in a matrix including a plurality of rows and columns. Two signal lines L (such as La1, Lb2) are provided with respect to each column of the image pick-up elements. To the signals lines L, output terminals 20A of the switching elements 20 are connected in a predetermined regular pattern. Details of the regular pattern will be described later. Each signal line L has an output terminal connected to a respective A/D converter 30. The A/D converter 30 has an output terminal connected to the shift register 40. The shift register 40 has an output terminal connected to the duplexer circuit 60. A single address line A (such as A1) is provided with respect to each row of the image pick-up elements. To each address line A, input/output gates 20B of all the switching elements 20 of the relevant row are connected. All the address lines A are connected to the address line selection circuit 50.

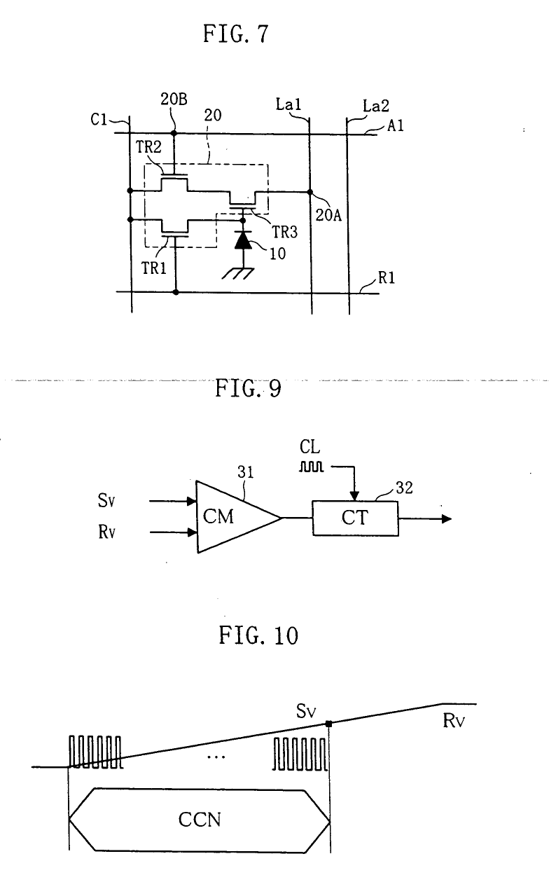

FIG. 7 is a circuit diagram of an image pick-up element. The switching element 20 comprises a reset transistor TR1, a switching transistor TR2 and a source follower amplifier transistor TR3. The reset transistor TR1 and the switching transistor TR2 comprise CMOS devices. Though not shown in FIG. 6, a reset line R is provided with respect to each row (the reset line for the first row is indicated by reference sign R1), and a common line C is provided with respect to each column (the common line for the first column is indicated by reference sign C1). The reset transistor TR1 has a source, a gate and a drain which are connected to the output terminal of the photodiode 10, the reset line R1 and the common line C1, respectively. The switching transistor TR2 has a source, gate and a drain which are connected to the common line C1, the address line A1 and the source of the source follower amplifier transistor TR3, respectively. The source follower amplifier transistor TR3 has a gate connected to the output terminal of the photodiode 10 and a drain connected to the signal line L11. The contact point between the drain of the source follower amplifier transistor TR3 and the signal line La1 corresponds to the output terminal 20A of the switching element 20, whereas the contact point between the gate of the switching transistor TR2 and the address line A1 corresponds to the input/output gate 20B of the switching element 20. In each pixel, when the switching element 20 is turned on with the input/output gate 20B in conduction, signal charge corresponding to the received amount of light flows from the photodiode 10 to the signal line, whereby signal voltage is inputted into the A/D converter 30 through the signal line.

Now, as an example, attention is focused on the image pick-up elements of the first column and the signal lines La1, La2, and the regular connection pattern thereof will be described. It is to be noted that the same regular pattern as that of the first column is applied to all other columns.

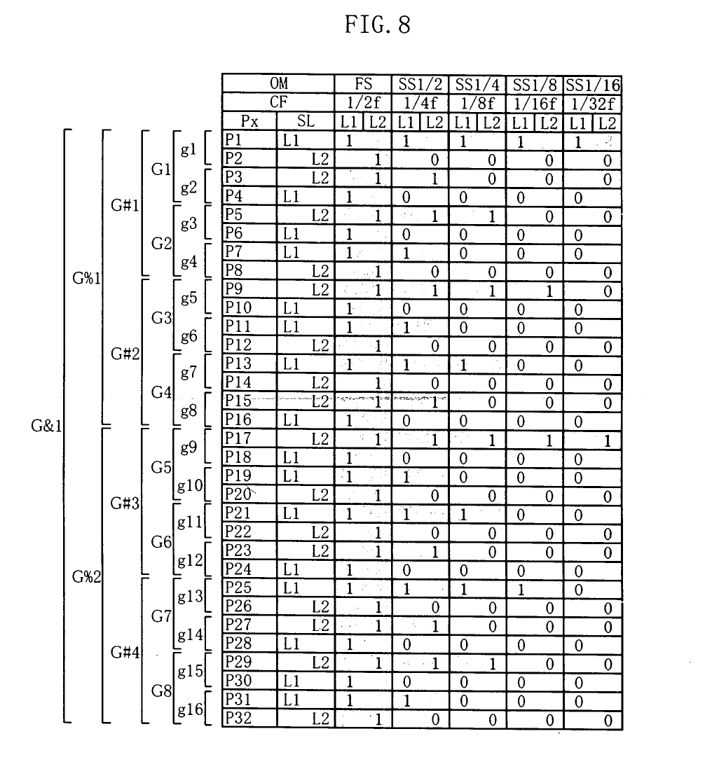

FIG. 8 shows the regular pattern of the first column. As shown in the figure, the image pick-up elements P1-P32 of the first column are divided into sub-groups (g1, g2, g3 . . . ) each of which consists of two image pick-up elements arranged adjacent to each other. The two image pick-up elements of each sub-group are connected to different signal lines L1 (La1), L2 (La2). Two adjacent sub-groups constitute a single group. For example, the group G1 consists of the sub-groups g1 and g2. The “OM”, “CF”, “Px” and “SL” in the figure mean the operation mode, clock frequency, pixel and signal line, respectively. Further, “1” means ON, whereas “0” means OFF.

Referring now to the group G1, the connection pattern of the sub-group g1 to the signal lines L1, L2 differs from the connection pattern of the sub-group g2 to the signal lines L1, L2. This holds true for other groups G2-G8. In each group, the two image pick-up elements located at the (2n+1)th positions (n=0, 1) are connected to different signal lines. For example, in the group G1, the image pick-up elements P1 and P3 are connected to different signal lines. In the group G2, the image pick-up elements PS and P7 are connected to different signal lines.

As shown in FIG. 8, the groups G1 and G2 constitute a parent group G#1. The parent group G#1 includes four (=2²) sub-groups (g1-g4). Similarly, the groups G3 and G4 constitute a parent group G#2, the groups G5 and G6 constitute a parent group G#3, and the groups G7 and G8 constitute a parent group G#4. Further, the parent groups G#1 and G#2 constitute a grandparent group G%1. The grandparent group G%1 includes eight (=2³) sub-groups (g1-g8). Similarly, the groups G#3 and G#4 constitute a grandparent group G%2. Further, the grandparent groups G%1 and G%2 constitute a great-grandparent group G&1. The great-grandparent group G&1 includes 16 (=2⁴) sub-groups (g1-g6).

As will be understood from FIG. 8, the signal line connection pattern of the parent group G#1 is the same as that of the parent group G#4, whereas the signal line connection pattern of the parent group G#2 is the same as that of the parent group G#3. However, the signal line connection pattern of the parent group G#1 is different from that of the parent group G#2. In the parent group G#1, the two image pick-up elements (P1 and P5) located at the (4n+1)th positions (n=0, 1) are connected to different signal lines La1 and La2. Similarly, in the parent group G#2, the two image pick-up elements (P9 and P13) located at the (4n+1)th positions (n=0, 1) are connected to different signal lines La1 and La2.

Moreover, in the grandparent group G%1, the two image pick-up elements (P1 and P9) located at the (8n+1) th positions (n=0, 1) are connected to different signal lines La1 and La2. Similarly, in the grandparent group G%2, the two image pick-up elements (P17 and P25) located at the (8n+1)th positions (n=0, 1) are connected to different signal lines La1 and La2. Further, in the great-grandparent group G&1, the two image pick-up elements (P1 and P17) located at the (16n+1) th positions (n=0, 1) are connected to different signal lines La1 and La2.

With such a regular pattern, in the full sampling scanning (in which signals are extracted from all the image pick-up elements), the two image pick-up elements of each sub-group (g1-g32) (such as the pair of P1 and P2 or the pair of P3 and P4) are turned on simultaneously. Specifically, by turning on the image pick-up elements P1 and P2 simultaneously, signal voltages for the first row and the second row are simultaneously inputted into the A/D converters 30 through signal lines. Subsequently, by turning on the image pick-up elements P3 and P4 simultaneously, signal voltages for the third row and the fourth row are simultaneously inputted into the A/D converters 30 through signal lines. (Similar operation is performed with respect to other columns.) In the case where one out of two address lines is selectively scanned (½ sampling scan), the image pick-up elements P1 and P3 are simultaneously turned on in the group G1, whereas the image pick-up elements P5 and P7 are simultaneously turned on in the group G2. In this way, signal voltages for two rows are simultaneously inputted into the A/D converters 30 through signal lines.

In the case of ¼ sampling scanning, the image pick-up elements P1 and P5 are simultaneously turned on in the parent group G#1, whereas the image pick-up elements P9 and P13 are simultaneously turned on in the parent group G#2. Similarly, in the case of ⅛ sampling scanning, the image pick-up elements P1 and P9 are simultaneously turned on in the grandparent group G%1, whereas the image pick-up elements P17 and P25 are simultaneously turned on in the grandparent group G%2. Further, in the case of 1/16 sampling scanning, the image pick-up elements P1 and P17 are simultaneously turned on in the group great-grandparent group G&1.

As shown in FIG. 9, each A/D converter 30 includes a comparator (CM) 31 and a counter 32 (CT). As shown in FIG. 10, signal voltage (Sv) (plotted in the figure) which is sampled and held as an analog signal is inputted into the comparator 31 through the signal line, and reference voltage (Rv) which changes in the form of a slope in proportion to the operation clock (See FIG. 4A) is also inputted into the comparator 31. The comparator 31 compares the inputted signal voltage Sv and reference voltage Rv and outputs a latch signal to the counter 32 when the both voltages correspond to each other. The counter 32 counts the clock number. Upon receiving the latch signal from the comparator 31, the counter 32 outputs the clock count number (CCN) at that time point to the shift register 40 as a digital image signal.

As shown in FIG. 6, the shift register 40 includes registers 41. Each of the registers 41 is connected to the output terminal of a corresponding A/D converter 30. The registers 41 are arranged in two rows correspondingly to the two A/D converters 30 provided with respect to each column. The group of registers corresponding to the signal lines L1 are connected to a first transfer line 42A, whereas the group of registers corresponding to the signal lines L2 are connected to a second transfer line 42B. In the shift register 40, digital image signals from the A/D converters 30 temporarily taken in the registers 41 are transferred one by one through the two transfer lines 42A, 42B in synchronization with shift pulses. At this time, the duplexer circuit 60 switches the transfer lines 42A, 42B at an appropriate timing in accordance with the operation of the shift register 40. For example, when the duplexer circuit 60 is connected to the first transfer line 42A, the duplexer circuit successively outputs the digital image signals on the first transfer line 42A. After the outputting is completed, the duplexer circuit 60 switches the connection to the second transfer line 42B to successively output the digital image signals on the second transfer line 42B. In this way, digital image signals for two lines are serially outputted at the shift register 40.

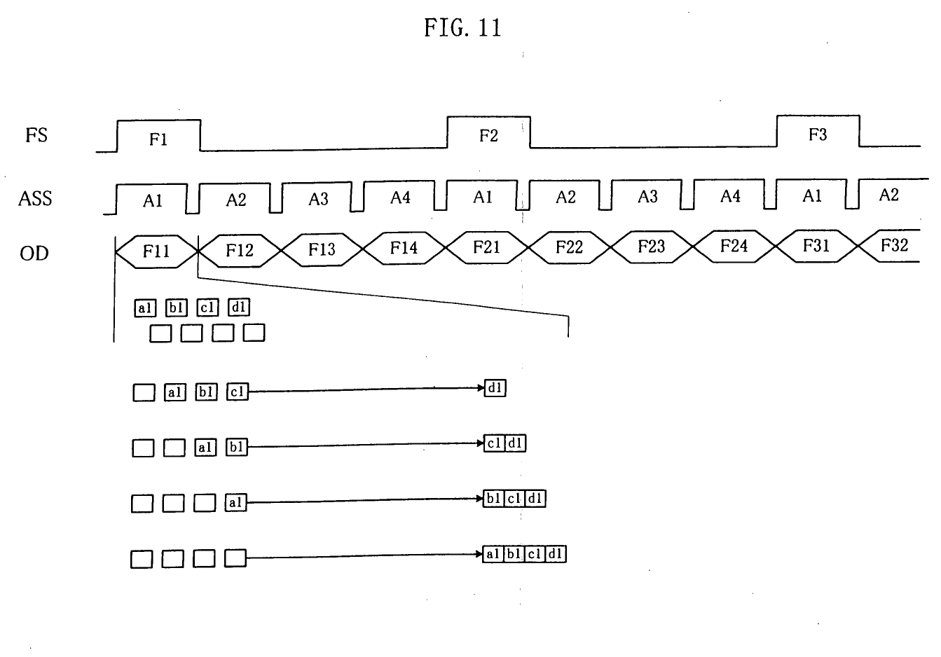

Referring to FIGS. 11 through 13, the operation of the area image sensor 1 will be described below. For easier understanding of the operation principle, it is assumed that the image pick-up portion 1A includes 16 pixels i.e., four columns and four rows.

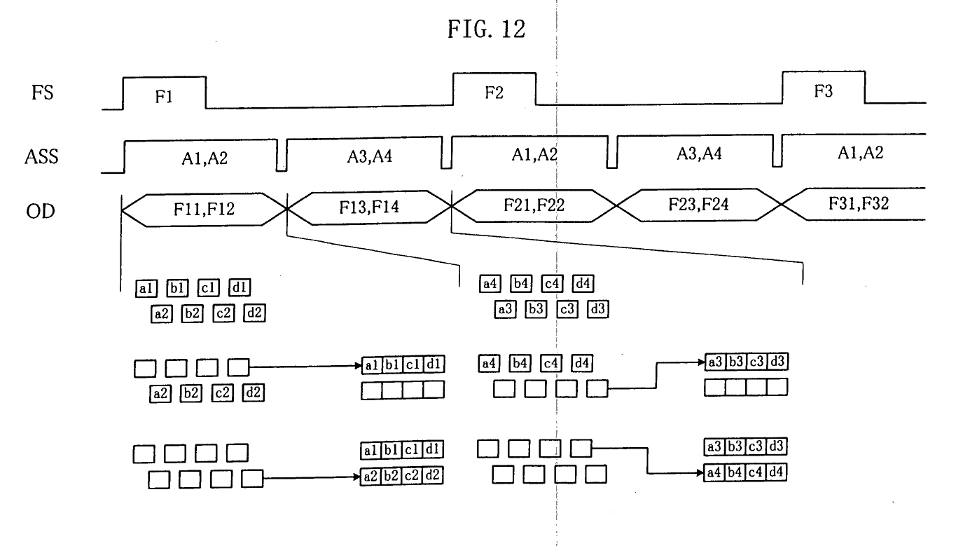

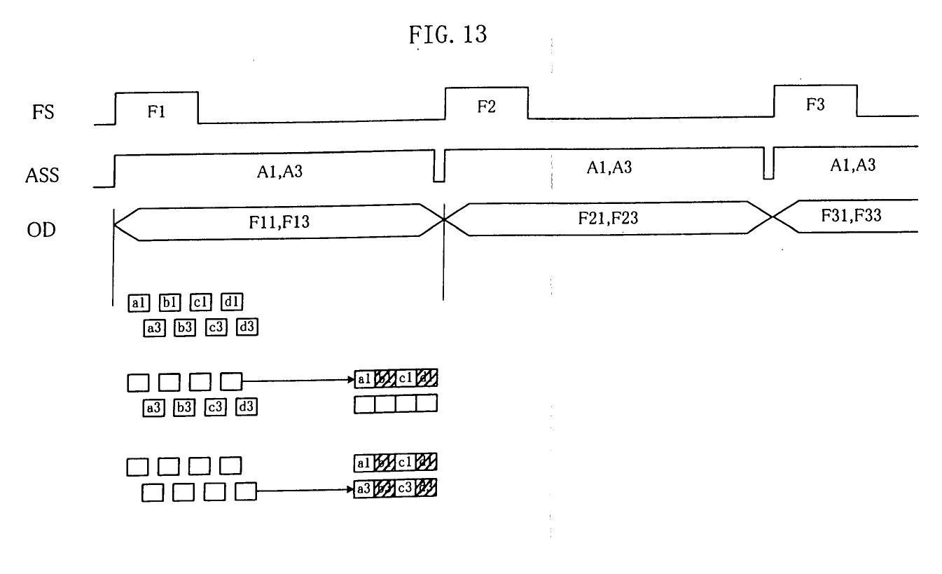

FIG. 11 shows full sampling scanning as the operation mode in which the address lines A1-A4 are selectively scanned one by one. It is to be noted that this mode is a comparative example and is not based on the present invention. FIG. 12 shows full sampling scanning in which two address lines are scanned simultaneously. FIG. 13 shows ½ sampling scanning in which every other address lines are scanned two lines at a time. In each of the figures, the timing chart is shown at the upper portion, whereas the operation of the shift register is schematically shown at the lower portion.

As shown in FIG. 11, in the case where the address lines A1-A4 are successively scanned one by one based on the address line selection signals ASS, the address line selection circuit 50 successively selects the address lines A1-A4 every time a frame signal FS (F1, F2, F3, . . . ) is asserted. Herein, the “frame signal” means a signal for giving a timing to periodically take the image data for one frame. The frequency of the frame signal corresponds to the frame rate.

When a single address line A1 is selected, the switching elements 20 of the first row connected to the address line A1 are turned on. At the same time, from the photodiodes 10 paired with the turned-on switching elements 20, signal voltages produced by photoelectric conversion are supplied to the A/D converters 30 through the signal lines. In FIG. 11, “OD” means output data. Further, “F11” means the data outputted when the address line A1 is selected in accordance with the frame signal F1. Similarly, “F23” means the data outputted when the address line A3 is selected in accordance with the frame signal F2.

As shown in FIG. 10, the A/D converter 30 compares the sloping reference voltage Rv with the signal voltage of analog input at each time of selective scanning. Then, the A/D converter 30 outputs, to the shift register 40, the clock count number at the time when the both voltages correspond to each other as a digital image signal. The shift register 40 outputs the digital image signals before a single selective scanning operation is completed. Similarly, thereafter, the address lines A2, A3 and A4 are scanned successively, and digital image signals of each row are outputted from the shift register 40 at each time of selective scanning. Thus, one cycle of the address line selection signal ASS and output data shown in FIG. 11 correspond to the line scanning cycle, and the processing for one frame is completed by four line scanning cycles. In such full sampling scanning, the A/D converter needs to perform the A/D conversion four times per one frame, so that the operation clock (clock frequency) is correspondingly set relatively high. The clock frequency in this case is defined as “f”.

Next, the actual full sampling scanning is considered in which the address lines A1-A4 are scanned two at a time. (It is assumed that the condition of the frame rate is the same as above.) In this case, as shown in FIG. 12, every time a frame signal is asserted, the address line selection circuit 50 selects two address lines simultaneously (A1 and A2, A3 and A4) for scanning.

Specifically, by first selecting the address lines A1 and A2 simultaneously, the switching elements 20 of the first and the second rows connected to the selected address lines are turned on. As a result, from the two rows of the photodiodes paired with the turned-on switching elements 20, signal voltages are supplied to the A/D converters 30 through signal lines.

The A/D converter 30 compares the reference voltage with the signal voltage at each time of selective scanning and outputs, to the shift register 40, the clock count number at the time when the both voltages correspond to each other as a digital image signal. The shift register 40 outputs the digital image signals of two rows before a single selective scanning operation is completed. Similarly, thereafter, the address lines A3 and A4 are simultaneously selected, and digital image signals of the two rows are outputted from the shift register 40. In this case, one cycle of the address line selection signal ASS and output data shown in FIG. 12 corresponds to the line scanning cycle, and the processing for one frame is completed by two line scanning cycles.

This sampling scanning differs from the full sampling scanning described before in that digital image signals for two rows can be obtained by a single selective scanning operation. As another difference, as shown in FIG. 12, the duplexer circuit 60 switches the transfer lines 42A, 42B of the shift register 40 within the line scanning cycle, so that digital image signals for two rows are serially outputted through the duplexer circuit 60. The duplexer circuit 60 switches the transfer lines 42A and 42B in such a manner that digital image signals can be outputted from the shift register 40 in the order of rows.

In this way, according to the full sampling scanning of the present invention, the A/D conversion by the A/D converters 30 is performed twice per one frame. Therefore, as compared with the foregoing full sampling scanning, the line scanning cycle can be set longer and the clock frequency can be set lower, i.e., set to about f/2.

Next, ½ sub full sampling scanning is considered on the assumption that the condition of frame rate is the same as above. In this case, as shown in FIG. 13, every time a frame signal F1, F2 is asserted, the address line selection circuit 50 simultaneously selects the address lines A1, A3 corresponding to the (2n+1)th locations (n=0, 1) in the group G1 for scanning. When the two address lines A1, A3 are selected simultaneously, the switching elements 20 of the first and the third rows connected to the address lines A1, A3 are turned on. At the same time, from the two rows of photodiodes 10 paired with the turned-on switching elements 20, signal voltages produced by photoelectric conversion are supplied to the A/D converters 30 through the signal lines L1, L2.

The A/D converter output a digital image signal to the shift register 40 at each time of selective scanning. The shift register 40 outputs digital image signals for the two rows before a single selective scanning operation is completed. In this case, one cycle of the address line selection signal ASS and output data shown in FIG. 13 corresponds to the line scanning cycle, so that the processing for one frame is completed by one line scanning cycle.

In such ½ sampling scanning, digital image signals for two rows are obtained by a single selective scanning operation. However, the obtained digital image signals are the data of alternate rows. Specifically, as shown in FIG. 13, the duplexer circuit 60 switches the transfer lines 42A, 42B within the line scanning cycle, so that digital image signals of alternate rows are serially outputted through the duplexer circuit 60. At this time, among the digital image signals of the alternate rows, the digital image signals of the second and the fourth columns are cancelled, as indicated by hatching in FIG. 13. Therefore, from 16 pixels of four rows and four columns, digital image signals for four pixels are finally extracted, so that the amount of data for one frame is ¼ of that of the full sampling scanning.

Therefore, according to the ½ sampling scanning, the A/D conversion by the A/D converter 30 is performed only once per one frame. Accordingly, the line scanning cycle can be set longer, and the clock frequency can be set to f/4. Similarly, based on this operation principle, in the cases of ¼ sampling scanning, ⅛ sampling scanning and 1/16 sampling scanning, the clock frequency can be set to f/9, f/16 and f/32, respectively.

Referring again to FIG. 8, in the full sampling scanning, image data for two rows such as the rows of P1 and P2, the rows of P3 and P4 can be obtained at a time, so that the clock frequency can be set to f/2.

In the case of the ½ sampling scanning, the image data for the two rows such as the rows of P1 and P3, the rows of P5 and P7 can be obtained at a time, so that the clock frequency can be set to f/4.

In the case of the ¼ sampling scanning, the image data for the two rows such as the rows of P1 and P5, the rows of P9 and P13 can be obtained at a time, so that the clock frequency can be set to about f/8.

Further, by obtaining the image data for the two rows of P1 and P9 at a time and the rows of P17 and P25 at a time, the clock frequency can be set to about f/16.

In the 1/16 sampling scanning which is the lowest sampling ratio, image data for two rows such as the rows of P1 and P17, the rows of P33 and P49 (P33 and the subsequent elements are not shown) can be obtained at a time, so that the clock frequency can be set to about f/32.

Therefore, in the ½ sampling scanning of this embodiment, for example, the operation clock can be decreased to f/4 as compared with the operation clock (clock frequency) f of the A/D converter in the operation mode in which the address lines A are selectively scanned one by one. Therefore, because of the proportional relationship between the operation clock and the power consumption, the power consumption can be considerably reduced.

In the case of the ¼ sampling scanning, the operation clock can be decreased to f/8, so that the power consumption can be further reduced. The ⅛ sampling scanning and the 1/16 sampling scanning are further advantageous in terms of the power consumption.

Moreover, by appropriately adjusting the operation clock of the A/D converter 30 during the sampling scanning or the line scanning cycle of the address line selection circuit 50, both of the increased frame rate and the reduced power consumption can be realized.

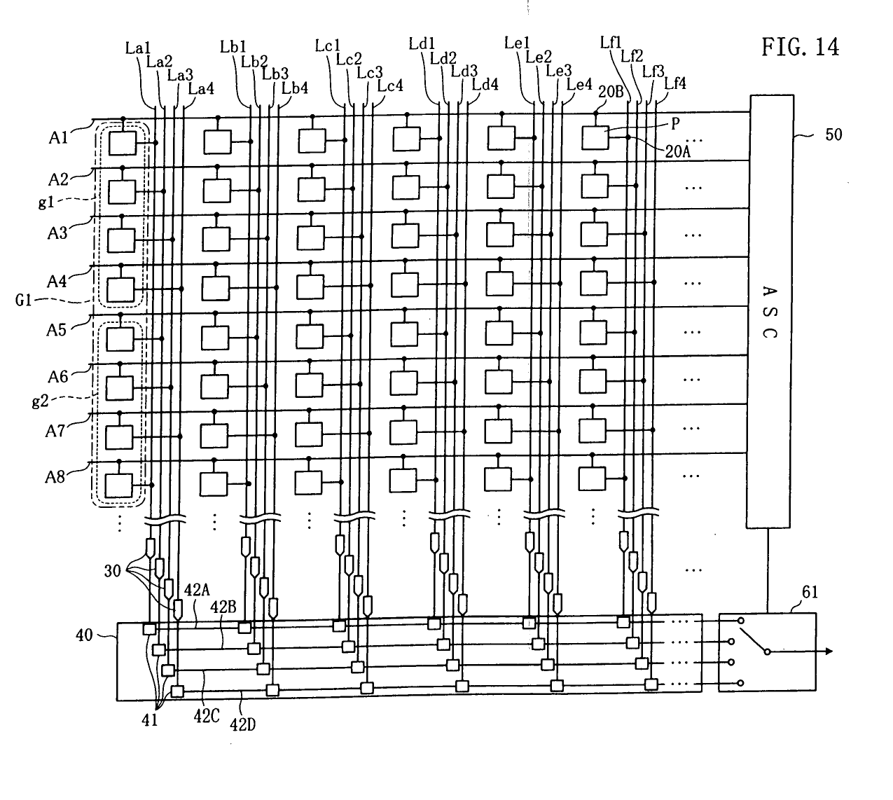

FIG. 14 is a block diagram of an area image sensor according to a third embodiment of the present invention. In the third embodiment, four signal lines are provided with respect to each column of image pick-up elements P. The image pick-up elements are connected to the signal lines in accordance with a regular pattern described below.

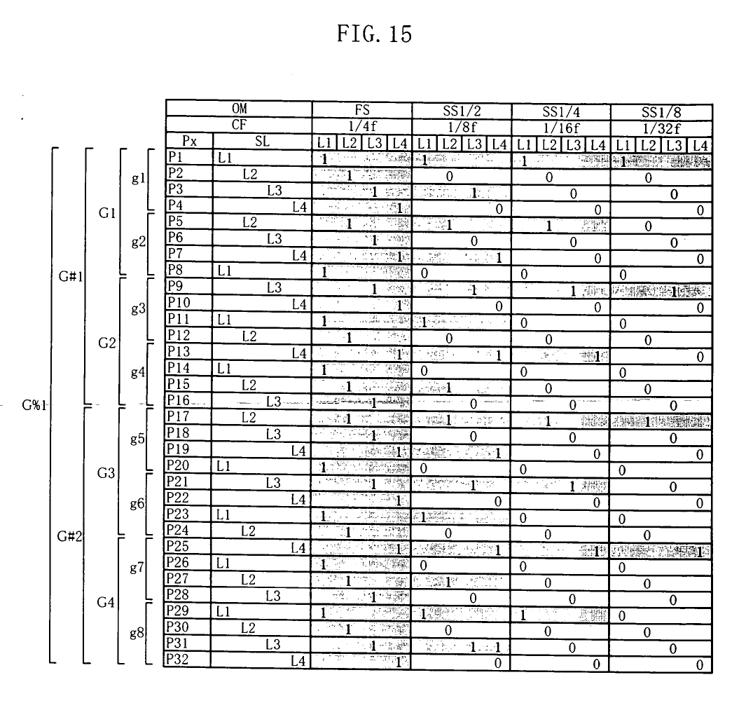

FIG. 15 shows the regular pattern of the first column according to the third embodiment. As shown in the figure, the image pick-up elements (P1, P2, . . . ) of the first column are divided into sub-groups (g1, g2, . . . ) each of which consists of four successive image pick-up elements. The four image pick-up elements of each sub-group are connected to different signal lines L1-L4. Two successive sub-groups constitute a single group. (For example, the sub-groups g1 and g2 constitute a group G1.)

Referring to the group G1, the connection pattern of the sub-group g1, which is included in this group, to the signal lines L1-L4 differs from the connection pattern of the sub-group g2 to the signal lines L1-L4. (This holds true for other groups G2, G3, . . . ) In each group G1, G2, . . . , the four image pick-up elements (such as P1, P3, P5, P7 or P9, P11, P13, P15) located at the (2n+1)th positions (n=0, 1, 2, 3) are connected to different signal lines L1-L4.

As will be understood from FIG. 15, in the parent group G#1, the four image pick-up elements (P1, P5, P9, P13) located at the (4n+1)th positions (n=0, 1, 2, 3) are connected to different signal lines L1-L4. Similarly, in the parent group G#2, the four image pick-up elements (P17, P21, P25, P29) located at the (4n+1)th positions (n=0, 1, 2, 3) are connected to different signal lines L1-L4. Further, in the grandparent group G%1, the four image pick-up elements (P1, P9, P17, P25) located at the (8n+1)th positions (n=0, 1, 2, 3) are connected to different signal lines L1-L4.

With such a regular pattern, in the case of full sampling scanning in which signals are extracted from all the image pick-up elements, four image pick-up elements such as P1-P4 or P5-P8 are turned on simultaneously so that signal voltages for successive four rows can be simultaneously inputted into the A/D converters 30 through the signal lines. In the case of the ½ sampling scanning in which one out of two address lines A is selectively scanned, the image pick-up elements P1, P3, P5, P7 are simultaneously turned on in the group G1, whereas the image pick-up elements P9, P11, P13, P15 are simultaneously turned on in the group G2. In this way, also in the ½ sampling scanning, signal voltages for four rows can be simultaneously inputted into the A/D converters 30 through the signal lines.

In the case of the ¼ sampling scanning, the image pick-up elements P1, P5, P9, P13 can be simultaneously turned on in the parent group G#1, whereas the image pick-up elements P17, P21, P25, P29 can be simultaneously turned on in the parent group G#2.

In the case of the ⅛ sampling scanning, the image pick-up elements P1, P9, P17, P25 are simultaneously turned on in the grandparent group G%1.

As shown in FIG. 14, in the shift register 40, the group of registers 41 corresponding to the signal lines L1 are connected to a first transfer line 42A, the group of registers 41 corresponding to the signal lines L2 connected to a second transfer line 42B, the group of registers 41 corresponding to the signal lines L3 connected to a third transfer line 42C, and the group of registers 41 corresponding to the signal lines L4 connected to a fourth transfer line 42D. Thus, the shift register 40 transfers digital image signals one by one through the four transfer lines 42A, 42B, 42C and 42D in synchronization with shift pulses. At this time, the multiplexer circuit 61 switches the four transfer lines 42A, 42B, 42C and 42D at an appropriate timing in accordance with the operation of the shift register 40. For example, the multiplexer circuit 61 successively outputs the digital image signals on the first transfer line 42A and then switches the connection to the second transfer line 42B to successively output the digital image signals on that line. Thereafter, the multiplexer circuit switches the connection to the third transfer line 42C and finally to the fourth transfer line 42D to output the digital image signals. With such a structure, the shift register 40 outputs digital image signals for four rows serially in each row.

Next, the operation of the third embodiment will be described. For easier understanding of the operation principle, it is assumed that the area image sensor includes image pick-up elements of only 48 pixels i.e., eight rows and six columns just shown in FIG. 14 and that peripheral circuits such as the A/D converters 30 and the shift register 40 are structured correspondingly.

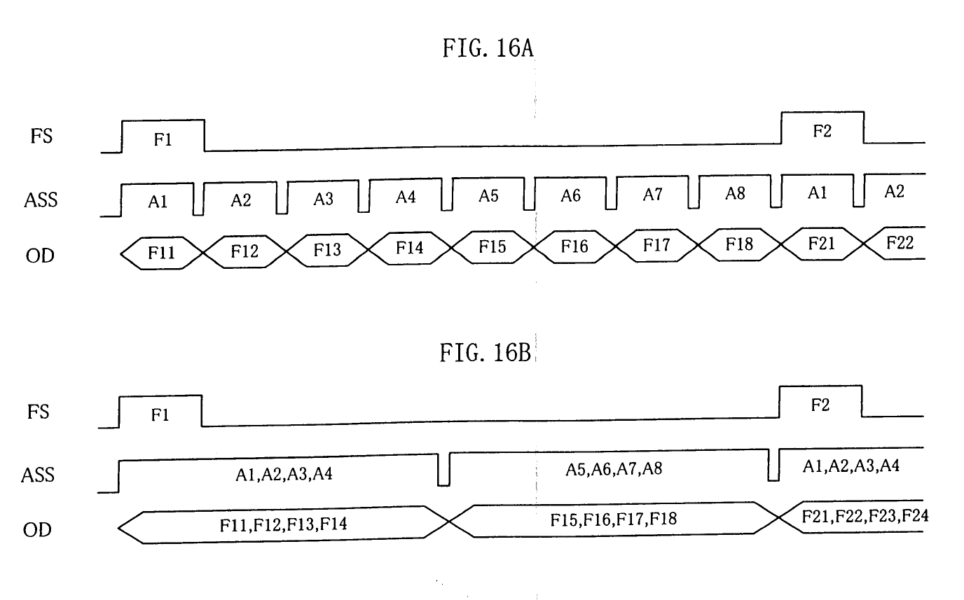

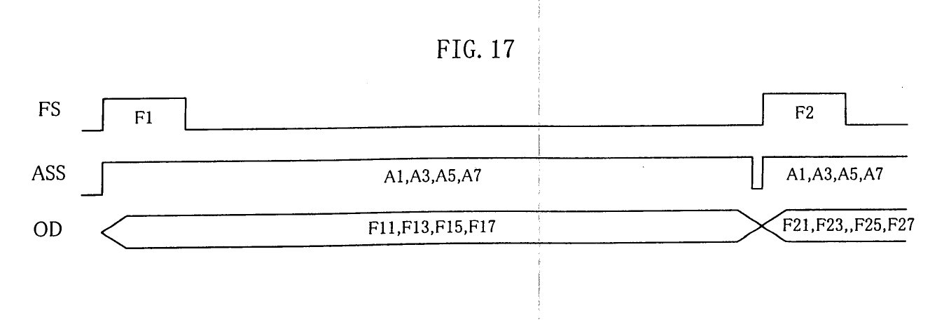

FIGS. 16 and 17 show the signal processing. Specifically, FIG. 16A is a timing chart of the full sampling scanning as the operation mode in which the address lines A1-A8 are selectively scanned one by one, FIG. 16B is a timing chart of the full sampling scanning in which all the address lines are scanned four lines at a time, and FIG. 17 is a timing chart of the ½ sampling scanning in which every other address lines are scanned four lines at a time. It is to be noted that FIG. 16A is for comparative reference only, and the operation mode in which the address lines A are scanned one by one does not exist.

As shown in FIG. 16A, if the full sampling scanning in which the address lines A1-A8 are successively scanned one by one is performed, the address line selection circuit 50 successively selects the address lines A1-A8 one by one every time a frame signal is asserted.

When a single address line A1 is selected for scanning, the image pick-up elements of the first row connected to the address line A1 are turned on. At the same time, from the image pick-up elements which are turned on, signal voltages are supplied to the A/D converters 30 through the signal lines such as La1, Lb1.

The A/D converters 30 output digital image signals to the shift register 40. The shift register 40 outputs the digital image signals before the single selective scanning operation is completed. Similarly, thereafter, the address lines A2, A3 and so on are successively scanned, and digital image signals of each row are outputted from the shift register 40 at each time of selective scanning. Thus, one cycle of the address line selection signal ASS and output data shown in FIG. 16A corresponds to the line scanning cycle, and the processing for one frame is completed by eight line scanning cycles. The A/D converter needs to perform A/D conversion eight times per one frame, so that the operation clock (clock frequency) is correspondingly set relatively high.

Next, the inventive full sampling scanning in which the address lines A1-A8 are scanned four lines at a time is considered on the assumption that the condition of the frame rate is the same as above. In this case, as shown in FIG. 16B, every time a frame signal is asserted, the address line selection circuit 50 selects the four address lines A1-A4 simultaneously and the four address lines A5-A8 simultaneously for scanning.

Specifically, by first selecting the four address lines A1-A4 simultaneously, the image pick-up elements P of the first through the fourth rows connected to the address lines A1-A4 are turned on. As a result, signal voltages are supplied from the turned-on image pick-up elements P to the A/D converters 30 through the signal lines L1-L4.

The A/D converters 30 output digital image signals to the shift register 40. The shift register 40 outputs the digital image signals for the four rows before the single selective scanning operation is completed. Similarly, thereafter, the address lines A5-A8 are scanned simultaneously, and digital image signals of four rows are outputted from the shift register 40. In this case, one cycle of the address line selection signal and output data shown in FIG. 16B corresponds to the line scanning cycle, and the processing for one frame is completed by two line scanning cycles.

This sampling scanning differs from the full sampling scanning described before in that digital image signals for four rows can be obtained by a single selective scanning operation. Further, since the multiplexer circuit 61 switches the transfer lines 42A, 42B, 42C, 42D of the shift register 40 within the line scanning cycle, digital image signals for four rows are serially outputted through the multiplexer circuit 61. The multiplexer circuit 61 switches the transfer lines 42A, 42B, 42C, 42D in such a manner that digital image signals from the shift register 40 can be outputted in the order of rows. For example, in the stage in which the image signals for the first four rows are outputted (i.e., the address lines A1-A4 are selectively scanned), the transfer lines are switched in the order of 42A, 42B, 42C, and 42D. In the stage in which the image signals for the next four rows are outputted (i.e., the address lines A5-A8 are selectively scanned), the transfer lines are switched in the order of 42B, 42C, 42D, 42A. According to the full sampling scanning, the A/D conversion by the A/D converters 30 is performed twice per one frame. Therefore, the line scanning cycle can be set long, and the clock frequency can be set lower than that of the foregoing full sampling scanning, i.e. set to about f/4.

Next the ½ sub full sampling scanning is considered on the assumption that the condition of the frame rate is the same as above. In this case, as shown in FIG. 17, every time a frame signal is asserted, the address line selection circuit 50 simultaneously selects address lines A1, A3, A5, A7 corresponding to the (2n+1)th locations (n=0, 1, 2, 3) in the group G1 for scanning.

When the four address lines A1, A3, A5, A7 are scanned simultaneously, the image pick-up elements P of the first, the third, the fifth, and the seventh rows connected to the address lines A1, A3, A5, A7 are turned on. At the same time, signal voltages are supplied from the turned-on image pick-up elements P to the A/D converters 30 through the signal lines L1-L4.

The A/D converters 30 output digital image signals to the shift register 40 at each time of selective scanning. The shift register 40 outputs digital image signals for the four rows before a single selective scanning operation is completed. In this case, one cycle of the address line selection signal and output data shown in FIG. 17 corresponds to the line scanning cycle, and the processing for one frame is completed by one line scanning cycle.

In such ½ sampling scanning, digital image signals for four rows are obtained by a single selective scanning operation. However, the obtained digital image signals are the data for alternate rows. In the shift register 40, the multiplexer circuit 61 switches the transfer lines in the order of 42A, 42C, 42B, 42D within the line scanning cycle, so that digital image signals of alternate rows are serially outputted through the multiplexer circuit 61. At this time, among the digital image signals of the alternate rows, the digital image signals of the second, the fourth and the sixth columns are cancelled. Therefore, from 48 pixels of eight rows and six columns, digital image signals for 12 pixels are finally extracted, so that the amount of data for one frame is ¼ of that of the full sampling scanning.

Therefore, according to the ½ sampling scanning of the third embodiment, the A/D conversion by the A/D converter 30 is performed only once per one frame. Therefore, the line scanning cycle can be set longer, and the clock frequency can be set to about f/8. Similarly, in the cases of ¼ sampling scanning and ⅛ sampling scanning, the clock frequency can be set to about f/16 and f/32, respectively.

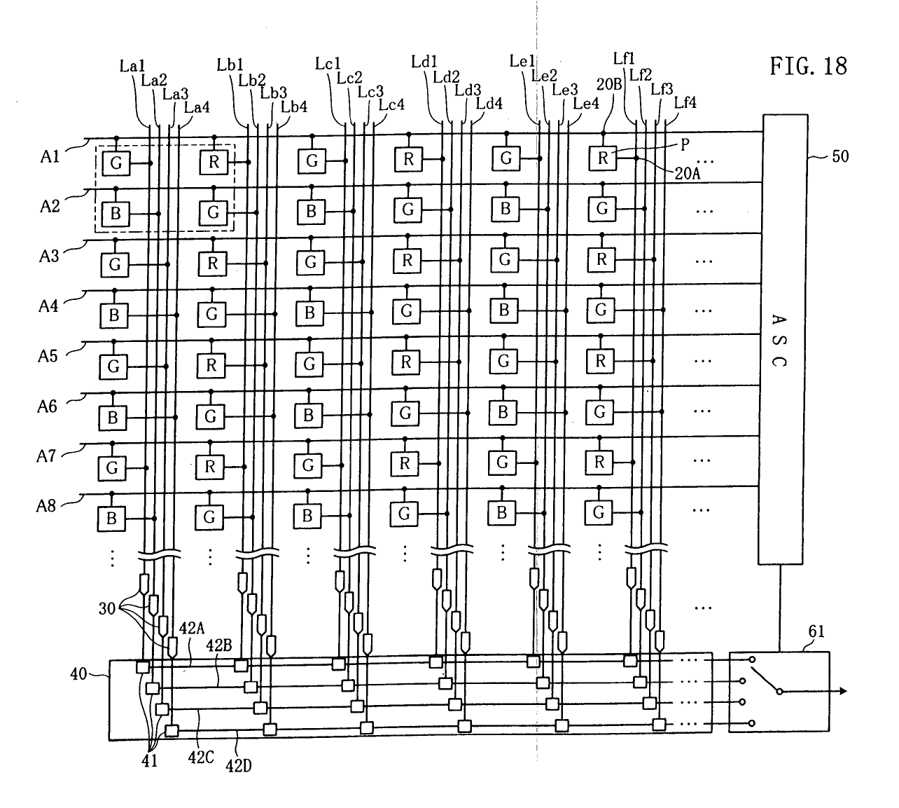

Next, a fourth embodiment will be described. FIG. 18 is a block diagram of an area image sensor according to the fourth embodiment. The area image sensor of the fourth embodiment is suitable for color imaging. Each of image pick-up elements is provided with a filter of either one of three primary colors RGB. Specifically, the image pick-up unit indicated by phantom lines and including image pick-up elements of two rows and two columns provides one pixel. For example, in each pixel, the color filter for the upper left image pick-up element is G, that for the upper right one is R, that for the lower left one is B and that for the lower right one is G, for example. In such a structure, each of the image pick-up elements is called a “sub-pixel”. Thus, one pixel corresponds to four sub-pixels.

In the fourth embodiment, the number of signal lines L for each column is the same as that of the third embodiment (i.e., four signal lines). However, the fourth embodiment differs from the third embodiment in the connection pattern of the signal lines and the image pick-up elements.

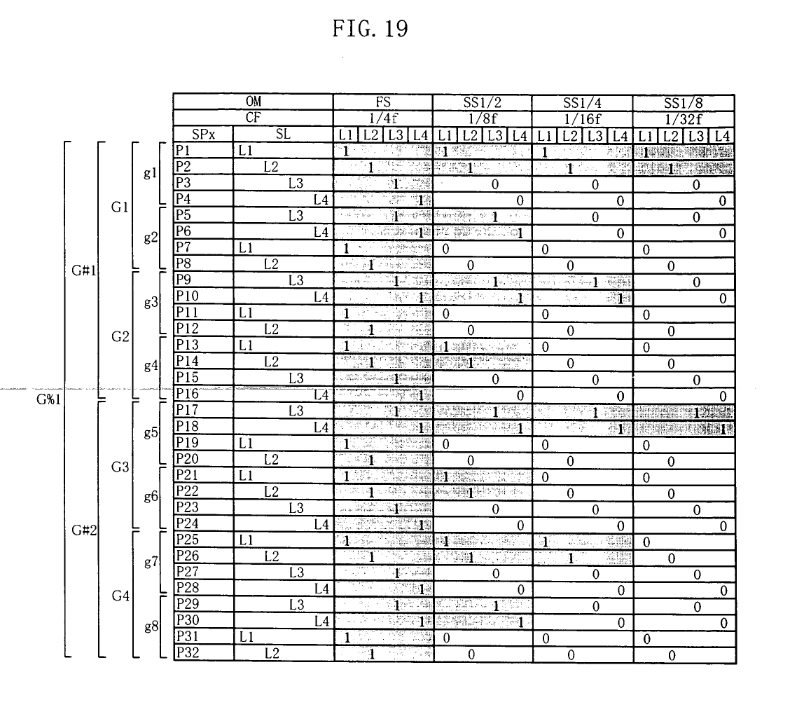

FIG. 19 shows the connection pattern of the image pick-up elements (sub-pixel SPX) of the first column according to the fourth embodiment. The group structure of the image pick-up elements of the fourth embodiment is the same as that of the third embodiment. As will be understood from the figure, there are only two patterns of signal line connection for the sub-groups (g1, g2, . . . ). Specifically, the connection pattern for each of the sub-groups g1, g4, g6 and g7 is [L1→L2→L3→L4]. On the other hand, the connection pattern for each of the sub-groups g2, g3, g5 and g8 is [L3→L4→L1→L2]. With such a structure, in each group G1, the four image pick-up elements located at the (4n+1)th positions and the (4n+2)th positions (n=0, 1) are connected to different signal lines L1-L4. Specifically, in the group G1, the image pick-up elements P1, P2, P5, P6 are connected to different signal lines L1-L4. In the group G2, the image pick-up elements P9, P10, P13, P14 are connected to different signal lines L1-L4.

Further, in each of the parent groups G#l and G#2, the four image pick-up elements located at the (8n+1)th positions and the (8n+2) th positions (n=0, 1) are connected to different signal lines L1-L4. Specifically, in the group G#1, the image pick-up elements P1, P2, P9, P10 are connected to different signal lines L1-L4, whereas, in the group G#2, the image pick-up elements P17, P18, P25, P26 are connected to different signal lines L1-L4. Further, in the grandparent group G%1, the four image pick-up elements (P1, P2, P17, P18) located at the (16n+1)th positions and the (16n+2)th positions (n=0, 1) are connected to different signal lines L1-L4.

With such a regular pattern, the operation in the full sampling scanning in which signals are extracted from all the image pick-up elements is the same as that in the third embodiment. In the ½ sampling scanning in which one out of two address lines A is selectively scanned, the image pick-up elements located at the first, the second, the fifth and the sixth positions are simultaneously turned on in each of the groups G1, G2, . . . . In this way, also in the ½ sampling scanning, signal voltages for four rows can be simultaneously inputted into the A/D converters 30 through signal lines.

In the case of the ¼ sampling scanning, the image pick-up elements located at the first, the second, the ninth and the tenth positions in each of the parent groups G#1 and G#2 (P1, P2, P9, P10 and P17, P18, P25, P26) can be simultaneously turned on.

In the case of ⅛ sampling scanning, the image pick-up elements 1P1, P2, P17, P18 located at the first, the second, the seventeenth, and the eighteenth positions in the grandparent group G% are turned on simultaneously. In this way, also in the ½ sampling scanning, the ¼ sampling scanning and the ⅛ sampling scanning, signal voltages for four rows can be simultaneously inputted into the A/D converters 30 through signal lines L.

In the case of the full sampling scanning, the address selection circuit 50 selectively scans four address lines (A1-A4 or A5-A8) simultaneously for conduction. In the ½ sampling scanning, while grouping into the unit of groups such as G1, G2, the address line selection circuit selectively scans four address lines (A1, A2, A5, A6) corresponding to the (4n+1)th and the (4n+2)th positions (n=0, 1) in each group G1, G2 simultaneously for conduction. In the case of the ¼ sampling scanning, the address line selection circuit 50 selectively scans four address lines (reference signs omitted) corresponding to the (8n+1)th and the (8n+2)th positions (n=0, 1) in each parent group G#1, G#2 simultaneously for conduction. In the case of the ⅛ sampling scanning, the address line selection circuit 50 selectively scans four address lines (reference sign omitted) corresponding to the (16n+1)th and the (16n+2)th positions (n=0, 1) in the grandparent group G%1 simultaneously for conduction. Thus, in any of the ½ sampling scanning, the ¼ sampling scanning and the ⅛ sampling scanning, four address lines A can be simultaneously turned on at each time of selective scanning.

Next, the operation of the fourth embodiment will be described. It is to be noted that the operation timing is the same as that of the third embodiment shown in FIGS. 16 and 17.

As the operation mode of the fourth embodiment, the ½ sub full sampling scanning is considered on the assumption that the frame rate is the same as the full sampling scanning. In this case, every time a frame signal is asserted, the address line selection circuit 50 simultaneously selects address lines A1, A2, A5, A6 corresponding to the (4n+1)th positions and the (4n+2)th positions (n=0, 1) in the group G1 for scanning.

When the four address lines A1, A2, A5, A6 are selected simultaneously, the image pick-up elements P of the first, the second, the fifth, and the sixth rows connected to the address lines A1, A2, A5, A6 are turned on. At the same time, signal voltages are supplied from the turned-on image pick-up elements P to the A/D converters 30 through the signal lines L1-L4.

The A/D converters 30 output digital image signals to the shift register 40. The shift register 40 outputs digital image signals for the four rows before a single selective scanning operation is completed. Thereafter, the similar operation is repeated with respect to the unit of the group G2. Therefore, similarly to the third embodiment, the processing for one frame is completed by one line scanning cycle in such ½ sampling scanning. The amount of data for one frame becomes ¼ of that of the full sampling scanning. The operation clock (clock frequency) of the A/D converter 30 can be set to about f/8.

Based on the same operation principle as that of the third embodiment, in the cases of the ¼ sampling scanning and the ⅛ sampling scanning, the clock frequency can be set to about f/16 and f/32, respectively.

In the ½ sampling scanning, image data for four rows connected to different signal lines L1-L4 such as the rows P1, P2, P5, P6 or the rows P9, P10, P13, P14 can be obtained at a time, so that the clock frequency can be set to about f/8.

In the ¼ sampling scanning, image data for four rows such as the rows P1, P2, P9, P10 or the rows P17, P18, P25, P26 can be obtained at a time, so that the clock frequency can be set to about f/16.

In the ⅛ sampling scanning which is the lowest sampling ratio, image data for four rows connected to different signal lines L1-L4 such as the rows P1, P2, P17, P18 or the rows P33, P34, P49, P50 (P33 and the subsequent rows are not shown) can be obtained at a time, so that the clock frequency can be set to about f/32.

A fifth embodiment will be described below.

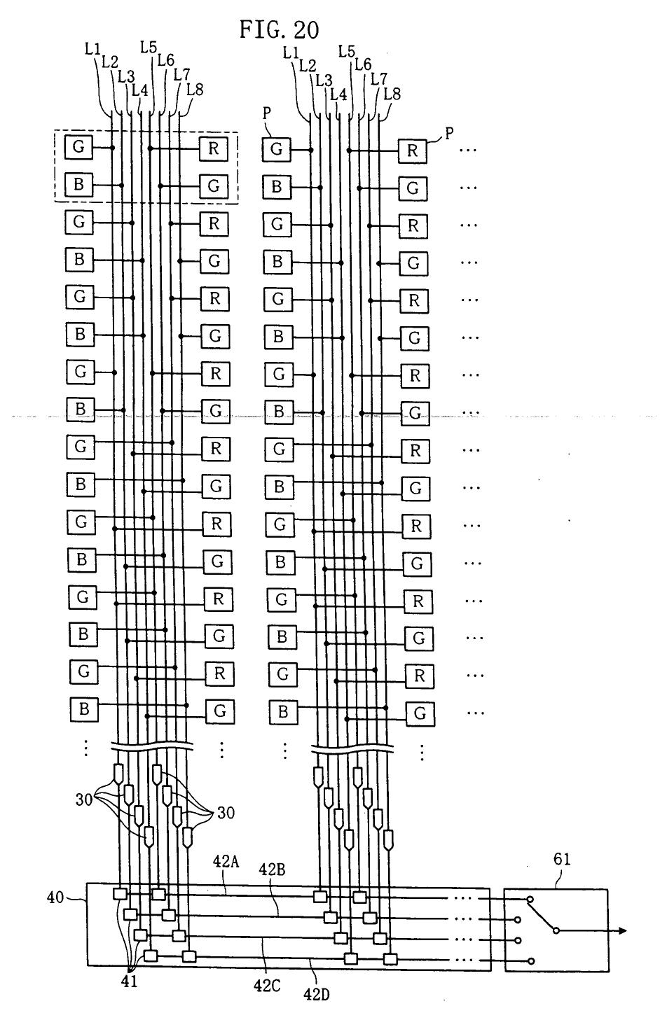

FIG. 20 is a block diagram of an area image sensor according to the fifth embodiment of the present invention. Similarly to the area image sensor of the fourth embodiment, the area image sensor of the fifth embodiment is suitable for color imaging. Color filters of the three primary colors RGB are arranged in the same pattern similar as that shown in FIG. 18. The image pick-up elements (sub-pixels) of two rows and two columns indicated by phantom lines provide one pixel.

In the fifth embodiment, eight signal lines are provided per two columns. (The number of signal lines for one column is four.)

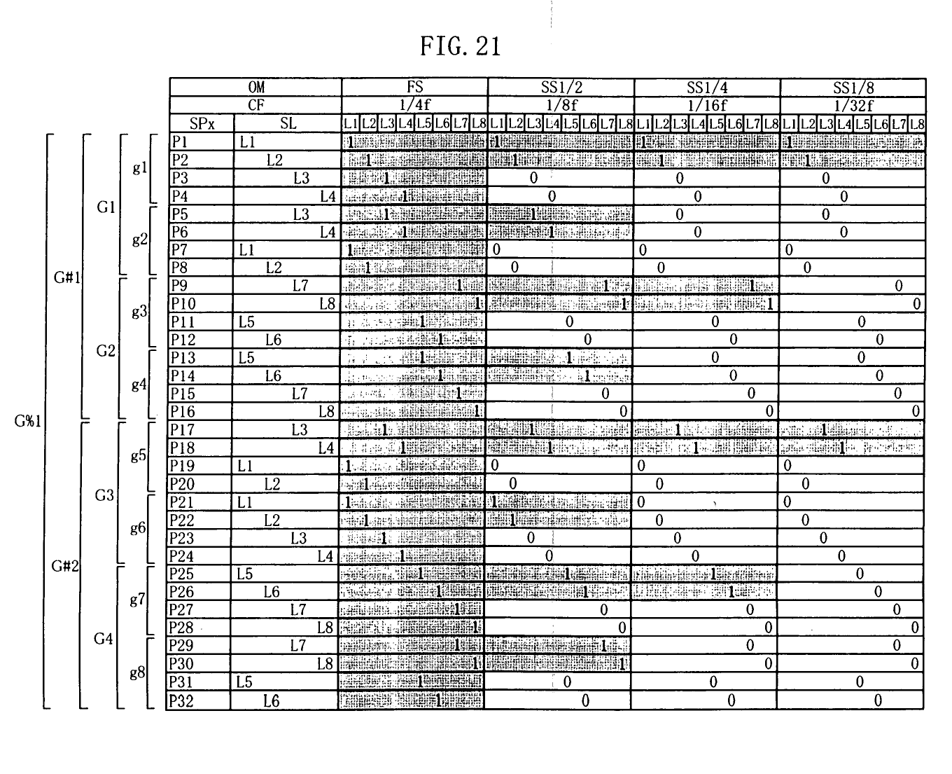

FIG. 21 shows the regular pattern of the first column of the fifth embodiment. The group structure of the fifth embodiment is the same as that of the fourth embodiment. Referring to the entirety of the first column, there are four connection patterns of the image pick-up elements of sub-groups (such as g1, g2) with respect to the signal lines L1-L8. Of the four connection patterns, two are the patterns for the signal lines L1-L4 only, whereas the remaining two are the patterns for the signal lines L5-L8 only. Therefore, in each of the groups (such as G1, G2), the four image pick-up elements located at the (4n+1)th positions and the (4n+2)th positions (n=0,1) such as the image pick-up elements P1, P2, P5, P6 or P9, P10, P13, P14 are connected to different signal lines (L1-L4, L5-L8), while corresponding to either of the group of signal lines L1-L4 and the group of signal lines L5-L8.

Further, the image pick-up elements P1, P2, P9, P10 located at the (8n+1)th positions and the (8n+2)th positions (n=0, 1) in the parent group G#1 are connected to different ones of the signal lines L1-L8, whereas the image pick-up elements P17, P18, P25, P26 located at the (8n+1)th positions and the (8n+2)th positions (n=0,1) in the parent group G#2 are connected to different ones of the signal lines L1-L8.

In the grandparent group G%1, the four image pick-up elements (P1, P2, P17, P18) located at the (16n+1)th positions and the (16n+2)th positions (n=0,1) are connected to different signal lines L1-L4.

As shown in FIG. 20, as for the entirety of the columns, the odd columns, i.e., the first and the third columns have the same connection pattern, while the even columns, i.e., the second and the fourth columns have the same connection pattern. Further, the connection patterns of the first and the second columns are symmetrical, while the connection patterns of the third and the fourth columns are also symmetrical.

With such a regular pattern again, the same operation as that of the fourth embodiment can be performed. Therefore, in any of the ½ sampling scanning, the ¼ sampling scanning and the ⅛ sampling scanning, signal voltage for four rows can be simultaneously inputted into the A/D converters 30 through appropriate four of eight signal lines L1-L8.

In the full sampling scanning, image data for four rows such as the rows P1-P4 or the rows P5-P8 constituting each sub-group can be obtained at a time, so that the clock frequency can be set to about f/4.

In the ½ sampling scanning, image data for four rows connected to different signal lines L1-L8, such as the four rows P1, P2, P5, P6 or the four rows P9, P10, P13, P14 can be obtained at a time, so that the clock frequency can be set to about f/8.

In the ¼ sampling scanning, while grouping into the parent groups G#1, G#2, image data for four rows connected to different signal lines L1-L8, such as the four rows of P1, P2, P9, P10 or the four rows of P17, P18, P25, P26 can be obtained at a time, so that the clock frequency can be set to about f/16.

In the ⅛ sampling scanning which is the lowest sampling ratio, image data for four rows connected to different signal lines L1-L4, such as the four rows of P1, P2, P17, P18 or the four rows of P33, P34, P49, P50 (P33 and the subsequent rows are not shown) can be obtained at a time, so that the clock frequency can be set to about f/32.

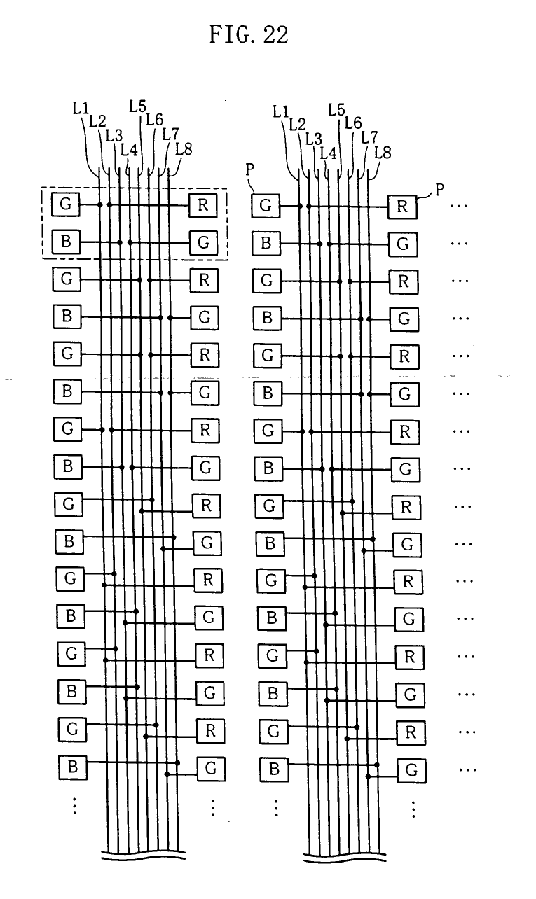

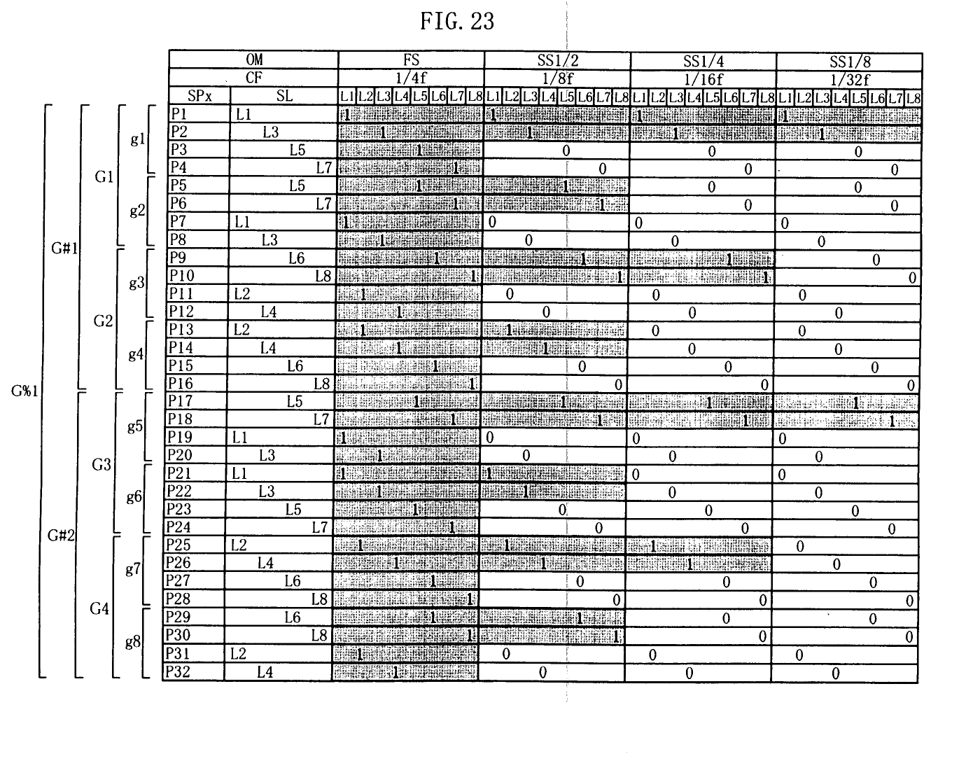

As a variation of the fifth embodiment, the structure as shown in FIGS. 22 and 23 may be employed.

In the variation again, eight signal lines are provided per two columns, and the number of signal lines for one column is four. Unlike the fifth embodiment, each pair of image pick-up elements facing each other are connected to adjacent signal lines. Therefore, in each of the groups such as G1, G2, the four image pick-up elements located at the (4n+1)th positions and the (4n+2)th positions (n=0, 1) (such as P1, P2, P5, P6 or P9, P19, P13, P14) are connected to different signal lines from each other (L1, L3, L5, L7 or L2, L4, L6, L8), while corresponding to either of the group of odd signal lines L1, L3, L5, L7 and the group of even signal lines L2, L4, L6, L8.

As for the parent groups G#1 and G#2, the four image pick-up elements (P1, P2, P9, P10 or P17, P18, P25, P26) located at the (8n+1)th positions and the (8n+2)th positions (n=0, 1) in each of the parent groups are connected to different signal lines L1-L8 from each other.

Further, in the grandparent group G%1, the four image pick-up elements (P1, P2, P17, P18) located at the (16n+1)th positions and the (16n+2)th positions (n=0, 1) are connected to different signal lines L1, L3, L5, L7.

With such a connection pattern again, an operation similar to that of the fifth embodiment can be performed.

In the case of color imaging, the color filter provided for each image pick-up element may comprise a complementary color filter for color separation into YMC and G.

The present invention being thus described, it is apparent that the same may be varied in many ways. Such variations should not be regarded as a departure from the spirit and scope of the present invention, and all such modifications as would be obvious to those skilled in the art are intended to be included within the scope of the following claims.

1. An area image sensor comprising a plurality of image pick-up elements arranged in a matrix including a plurality of element rows and a plurality of element columns;
a plurality of signal lines allocated to a respective one of the element columns; and
a plurality of A/D converters connected to the signal lines, respectively;
wherein each of the image pick-up elements belonging to said one of the element columns is connected to only one of the signal lines, and wherein each of the signal lines is connected to at least one of the image pick-up elements belonging to said one of the element columns.

2. The sensor according to claim 1, wherein each of the image pick-up elements comprises a photoelectric conversion element, and a switching element connected to the photoelectric conversion element.

3. The sensor according to claim 1, two adjacent image pick-up elements belonging to said one of the element columns are connected to different ones of the signal lines.

4. The sensor according to claim 1, further comprising a plurality of address lines and an address line selection circuit connected to the address lines, wherein each of the address lines is connected to the image pick-up elements of a respective one of the element rows, and wherein the address line selection circuit selects plural ones of the address lines simultaneously.

5. The sensor according to claim 1, further comprising a shift register connected to the A/D converters.

6. An area image sensor including a plurality of image pick-up elements arranged in a plurality of columns and a plurality of rows, the area image sensor comprising:
a plurality of signal lines allocated to a respective one or two of the columns of the image pick-up elements; and
A/D converters connected to the signal lines, respectively;
wherein small groups each consisting of successive image pick-up elements are defined in each of the columns of the image pick-up elements, the number of the image pick-up elements included in each of the small groups corresponding to the number of the signal lines allocated to the column, the image pick-up elements included in each of the small groups being connected to different signal lines from each other;
wherein large groups each consisting of at least two successive small groups are defined in each of the columns of the image pick-up elements, and wherein, in each of the large groups, there are at least two connection patterns of the image pick-up elements to the signal lines on a small group basis.

7. The area image sensor according to claim 6, wherein, in each of the columns of the image pick-up elements, the number of the small groups included in each of the large groups is powers of 2.

8. The area image sensor according to claim 6, wherein, two or more kinds of large groups differing from each other in number of the small groups included therein are defined in each of the columns of the image pick-up elements.

9. The area image sensor according to claim 6, further comprising address lines each of which is allocated to a respective one of the rows of the image pick-up elements and connected to all the image pick-up elements of the row, an address line selection circuit for selecting plural ones of the address lines simultaneously, a shift register for taking in digital signals outputted from each of the A/D converters and outputting the digital signals through a plurality of transfer lines, and a duplexer circuit or a multiplexer circuit for switching the transfer lines for outputting the digital signals.

10. The area image sensor according to claim 6, wherein the A/D converter compares an inputted signal voltage with a predetermined reference voltage and outputs, to the shift register, a count value when the both voltages correspond to each other as a digital signal.
